(19) United States
(12) Patent Application Publication
(10) Pub. No.: US 2026/0368345 A1
(43) Pub. Date: Nov. 19, 2026

(54) SYSTEMS AND METHODS FOR USING AGENTIC ARTIFICIAL INTELLIGENCE FOR CYBERSECURITY WITH SELF-RESEARCH AND SELF-HEALING

(71) Applicant: JPMORGAN CHASE BANK, N.A., New York, NY (US)

(72) Inventors: Vikas MALIK, Dublin, OH (US); Jonathan GIGLIO, Marion, OH (US)

(21) Appl. No.: 19/443,833

(22) Filed: Jan. 8, 2026

Related U.S. Application Data
(60) Provisional application No. 63/808,396, filed on May 19, 2025.

(51) Int. Cl. G06F 21/62; G06F 21/57

(52) U.S. Cl. CPC G06F 21/6218; G06F 21/577

(57) ABSTRACT

A method may include: performing, by a senior penetration tester artificial intelligence (AI) agent, an initial breach on an information system using SQL injection; prompting, by the senior penetration tester AI agent, a large language model (LLM) for potential entry points from results of the initial breach; exfiltrating, by a data exfiltration specialist AI agent, sensitive data from the results of the initial breach, resulting in an exfiltration report; prompting, by a vulnerability researcher AI agent, the LLM to analyze the exfiltration report and identify exploited vulnerabilities; prompting, by a common vulnerability exposure (CVE) researcher AI agent, the LLM to find all active CVEs matching the identified exploited vulnerabilities; performing, by a security mitigation expert AI agent, mitigation planning; and implementing, by a database security engineer AI agent, security hardening measures on the information system based on the mitigation planning.

### RELATED APPLICATIONS

This application claims priority to, and the benefit of, U.S. Provisional Patent Application Ser. No. 63/808,396 filed May 19, 2025, the disclosure of which is hereby incorporated, by reference, in its entirety.

### BACKGROUND OF THE INVENTION

### 1. Field of the Invention

Embodiments relate to systems and methods for using agentic artificial intelligence for cybersecurity with self-research and self-healing.

### 2. Description of the Related Art

Cyber Offense and Defense are moving faster than the industry can keep up. The future of Cyber Security will come down to artificial intelligence (AI) versus AI as the infrastructure becomes ever vaster and more complex while the cost and ease of use drive accessibility to these technologies. Agentic AIs have democratized access to tools needed to compromise infrastructure. Thus, by using these tools, cyber criminals now have the capabilities of many penetration testers. AI inference patterns are highly effective and comprehensive autonomous attacks can compensate for deterministic behavior.

### SUMMARY OF THE INVENTION

Systems and methods for using agentic artificial intelligence for cybersecurity with self-research and self-healing are disclosed. In one embodiment, a method may include: performing, by a senior penetration tester artificial intelligence (AI) agent executed by an electronic device, an initial breach on an information system using SQL injection; prompting, by the senior penetration tester AI agent executed by the electronic device, a large language model (LLM) for potential entry points from results of the initial breach; exfiltrating, by a data exfiltration specialist AI agent executed by the electronic device, sensitive data from the results of the initial breach, resulting in an exfiltration report; prompting, by a vulnerability researcher AI agent executed by the electronic device, the LLM to analyze the exfiltration report and identify exploited vulnerabilities; prompting, by a common vulnerability exposure (CVE) researcher AI agent executed by the electronic device, the LLM to find all active CVEs matching the identified exploited vulnerabilities; performing, by a security mitigation expert AI agent executed by the electronic device, mitigation planning; and implementing, by a database security engineer AI agent executed by the electronic device, security hardening measures on the information system based on the mitigation planning.

In an embodiment, the method may also include: generating, by a technical report writer AI agent executed by the electronic device, a final report.

In an embodiment, each of the prompts may include a persona for the LLM to assume and a task for the LLM to perform.

In an embodiment, the task in the prompt from the senior penetration tester AI agent may include identify and exploit database vulnerabilities from results of the SQL injection.

In an embodiment, the task in the prompt from the data exfiltration specialist AI agent may include exfiltrate and structure stolen data into reports.

In an embodiment, the task in the prompt from the vulnerability researcher AI agent may include analyze exploited vulnerabilities and create a technical report, including vulnerability types, exploit methods, and impacted components.

In an embodiment, the task in the prompt from the CVE researcher AI agent may include find active CVEs matching identified vulnerabilities.

In an embodiment, the task in the prompt from the security mitigation expert AI agent may include recommend and implement security mitigations.

In an embodiment, the task in the prompt from the database security engineer AI agent may include implement the security hardening measures.

In an embodiment, the security hardening measures comprise applying patches, modifying configurations, and/or enabling security features.

According to another embodiment, a non-transitory computer readable storage medium may include instructions stored thereon, which when read and executed by one or more computer processors, cause the one or more computer processors to perform steps comprising: performing an initial breach on an information system using SQL injection; prompting a large language model (LLM) for potential entry points from results of the initial breach; exfiltrating sensitive data from the results of the initial breach, resulting in an exfiltration report; prompting the LLM to analyze the exfiltration report and identify exploited vulnerabilities; prompting the LLM to find all active CVEs matching the identified exploited vulnerabilities; performing mitigation planning; and implementing security hardening measures on the information system based on the mitigation planning.

In an embodiment, the non-transitory computer readable storage medium may also include instructions stored thereon, which when read and executed by the one or more computer processors, cause the one or more computer processors to perform steps comprising: generating a final report.

In an embodiment, each of the prompts may include a persona for the LLM to assume and a task for the LLM to perform.

In an embodiment, the task may include identify and exploit database vulnerabilities from results of the SQL injection.

In an embodiment, the task may include exfiltrate and structure stolen data into reports.

In an embodiment, the task may include analyze exploited vulnerabilities and create a technical report, including vulnerability types, exploit methods, and impacted components.

In an embodiment, the task may include find active CVEs matching identified vulnerabilities.

In an embodiment, the task may include recommend and implement security mitigations.

In an embodiment, the task may include implement the security hardening measures.

In an embodiment, the security hardening measures comprise applying patches, modifying configurations, and/or enabling security features.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for using agentic artificial intelligence for cybersecurity with self-research and self-healing according to an embodiment;

FIG. 2 depicts a method for using agentic artificial intelligence for cybersecurity with self-research and self-healing according to an embodiment;

FIG. 3 depicts an exemplary computing system for implementing aspects of the present disclosure.

### DETAILED DESCRIPTION OF PREFERRED EMBODIMENTS

Embodiments relate to systems and methods for using agentic artificial intelligence for cybersecurity with self-research and self-healing.

Embodiments may use agentic AI for cyber defense. For example, AI agents may be used to identify and patch vulnerabilities within digital systems, serving as a robust line of defense in the digital realm. This defensive AI provides rapid, automated responses to emerging threats, highlighting the necessity for cyber defenders to harness AI technology to maintain security and resilience.

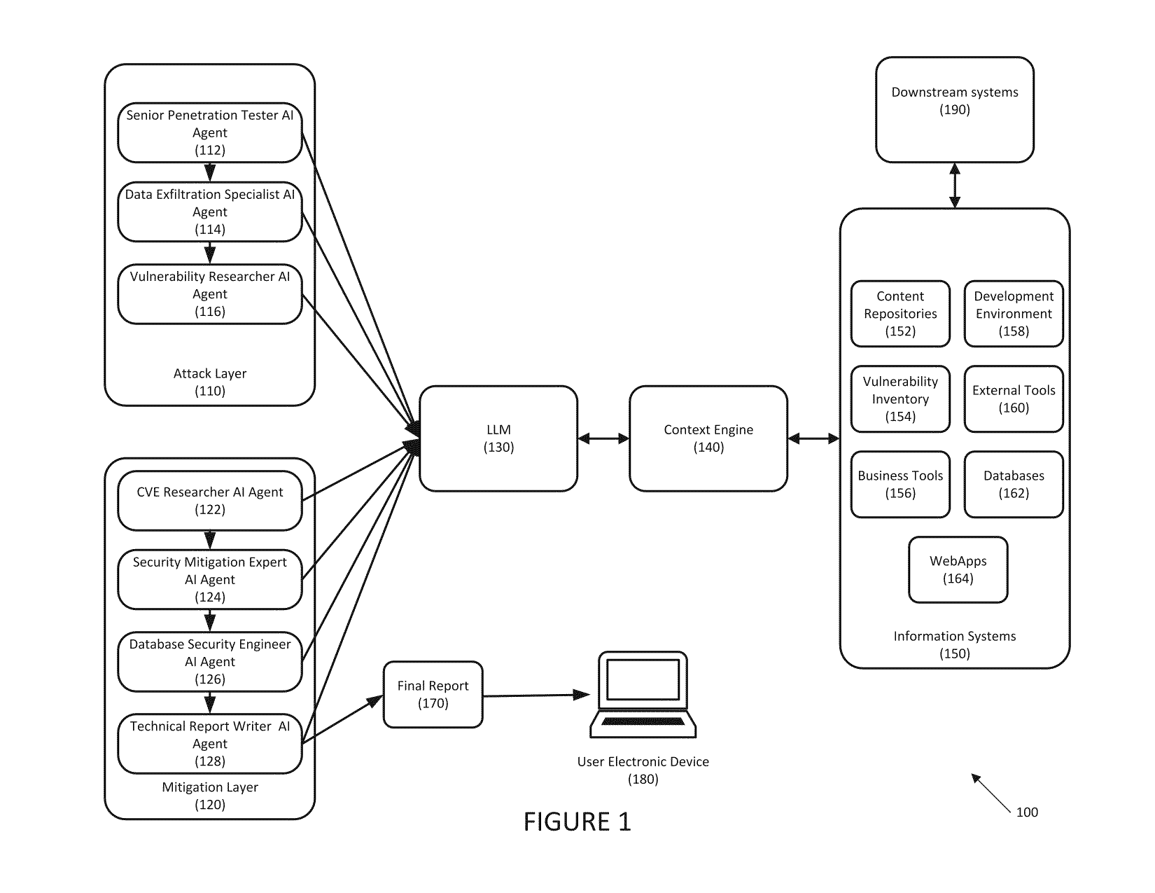

Referring to FIG. 1, a system for agentic artificial intelligence is disclosed according to an embodiment. System 100 may include attack layer 110, which may prospect and find weaknesses and attack systems; mitigation layer 120 that fixes vulnerabilities in response to events; large language model (LLM) 130 that provides automation and independent thinking to AI agents in the attack and mitigation layers; context engine 140 that provides context to make decisions about the information systems; and information systems 150 that provide information to AI agents.

Attack layer 110 and mitigation layer 120 may be hosted by one or more electronic devices (e.g., computers, servers (physical and/or cloud-based), etc.).

Attack layer 110 may include several AI agents, including senior penetration AI agent 112, data exfiltration AI agent 124, and vulnerability researcher AI agent 126. Each AI agent may be computer program executed by the electronic device that hosts attack layer 110.

Senior penetration AI agent 112 may perform initial database breach testing.

Data exfiltration AI agent 124 may exfiltrate sensitive data from the breach results from senior penetration AI agent 112.

Vulnerability researcher AI agent 126 may analyze the output from data exfiltration AI agent 124 to identify exploited vulnerabilities and may create technical report. The technical report may include vulnerability types, exploitation methods, and any impacted components.

Mitigation layer 120 may include common vulnerability exposure (CVE) researcher AI agent 122, security mitigation expert AI agent 124, database security engineer AI agent 126, and technical report writer AI agent 128. These agents may be named based on the persona for their tasks.

Each AI agent may be computer program executed by the electronic device that hosts mitigation layer 120.

CVE researcher AI agent 122 may prompt LLM 130 to find active CVEs matching the identified vulnerabilities from attack layer 110.

Security mitigation expert AI agent 124 may create a mitigation plan based on the CVE findings and the vulnerability analysis.

Database security engineer AI agent 126 may perform database hardening, such as implementing security hardening measures on the database, such as applying patches, modifying configurations, and enabling security features.

Technical report writer AI agent 128 may generate final report 170 that may be provided to user electronic device 180, such as an electronic device used by management.

Each AI agent may have a specific role or persona (e.g., senior penetrator, data exfiltrator, vulnerability researcher, CVE researcher, security mitigation researcher, database security engineer, and technical report writer), a specific goal (e.g., penetration testing, exfiltrate data, research vulnerabilities, research CVEs, research security mitigations, apply mitigations, and write a technical report), and a resume (e.g., based on persona).

Each of AI agents 112, 114, 116, 122, 124, 126, 128 may interface with LLM 130, and may prompt LLM 130 for responses. The result of each AI agent 112, 114, 116, 122, 124, 126, 128 may be provided to the next AI agent.

AI agents 112, 114, 116, 122, 124, 126, 128 may interface with information systems 150, which may include, for example, content repositories 152, vulnerability inventories 154, business tools 156, development environment 158, external tools 160, databases 162 (internal and external), webapps 164, etc. One or more of the information systems 150 may be the target of an attack by attack layer 110, and may be protected by mitigation layer 120.

Context engine 140 may interface with information systems 150 and may direct communications from attack layer 110 and/or mitigation layer 120 to one or more information system 150. In one embodiment, context engine 140 may maintain an inventory of information systems 150 and, depending on the communication from attack layer 110 and/or mitigation layer 120, may route the communication to one or more information systems 150.

Downstream systems 190 may access information systems 150. An objective is to protect information systems 150 from attacks from downstream systems 190.

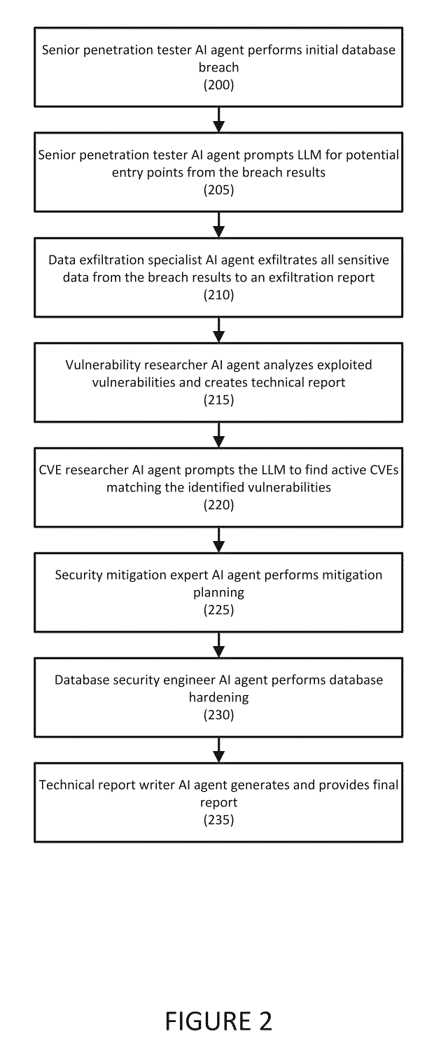

Referring to FIG. 2, a method for using agentic artificial intelligence for cybersecurity with self-research and self-healing is disclosed according to an embodiment. At a high level, the attack layer AI agents may identify issues, and then the AI agents in the mitigation layer perform mitigation actions to mitigate the issues. A final result is then output.

In step 200, a senior penetration tester AI agent may perform an initial database breach on one or more information system, such as content repositories, vulnerability inventories, business tools, development environment, external tools, databases (internal and external), webapps, etc. Senior penetration tester AI agent may use, for example, SQL injection.

SQL injection is the injection of malicious data or information while querying any database. For example, the senior penetration tester AI agent may perform SQL injection by interacting with a web application and identifying input fields (e.g., login forms, search boxes, URL parameters) that might be connected to a database. The senior penetration tester AI agent may submit various test inputs, such as ' OR '1'='1; admin' --; "; DROP TABLE users; --; etc. It may then analyze the application’s responses to determine if the input is being used in SQL queries without proper sanitization.

Based on the responses, the senior penetration tester AI agent may generate more sophisticated SQL injection payloads tailored to the specific database and application logic.

Next, the senior penetration tester AI agent may systematically try different payloads to bypass authentication, to extract data (e.g., using UNION SELECT), to modify or delete data, to escalate privileges, etc.

If successful, the senior penetration tester AI agent can automate the extraction of sensitive information by parsing the returned data and iteratively refining its queries.

The malicious data (SQL injection payloads) may be generated by the senior penetration tester AI agent itself, based on its programming, training, or prompts. The senior penetration tester AI agent may use predefined payload libraries, dynamic payload generation based on observed application behavior, machine learning to adapt and optimize its attack strategy, etc.

The initial database breach results from the SQL injection may be provided in a file, such as in a CSV file format.

In step 205, the senior penetration tester AI agent may prompt an LLM with the results of the SQL injection to identify potential entry points such as login pages, search boxes, and URL parameters where user input is received. This may result in the identification of breach results.

For example, the senior penetration tester AI agent may provide the LLM with a persona (e.g., “An expert in database systems with 12+ years red team experience”) and a task (e.g., “Identify and exploit database vulnerabilities from the results of the SQL injection”).

In step 210, a data exfiltration specialist AI agent may receive the breach results from the LLM and may exfiltrate all sensitive data from the breach results, resulting in an exfiltration report. Sensitive data may include any PII information regarding the customer/users of the application and or the account details and the privileges accorded to the users.

In one embodiment, two documents may be created. For example, the exfiltration report including the exfiltrated sensitive data may be created in a word processing format, and the sensitive data may be provided in a comma separated value (CSV) format.

For example, the data exfiltration specialist AI agent may provide the LLM with a persona (e.g., “A former cybersec forensic analyst turned offensive operator that is an expert in data extraction and covert exfiltration techniques”) and a task (e.g., “exfiltrate and structure stolen data into reports”).

In step 215, a vulnerability researcher AI agent may analyze the exfiltration report to identify exploited vulnerabilities and may create one or more technical reports. The technical report may include vulnerability types, exploitation methods, and any impacted components.

For example, the vulnerability researcher AI agent may provide the LLM with a persona (e.g., “Security researcher with deep knowledge of database vulnerabilities and common misconfigurations. Certified OSCP and OSCE holder.”) and a task (e.g., “Analyze exploited vulnerabilities and create technical report, and include vulnerability types, exploit methods, and impacted components”).

In step 220, a CVE researcher AI agent may prompt the LLM for the MITRE ATT&CK latest data on Common Vulnerabilities Exposed (CVEs) based on the output of the vulnerability researcher AI agent, and may make a call to that data source to retrieve the information needed for the getting the CVSS score and the remediation information. It may then prompt the LLM for preparing a report. This may include using common vulnerability scoring system (CVSS) scores and official remediation guidance for the CVEs.

For example, the CVE researcher AI agent may provide the LLM with a persona (e.g., “Sec intelligence specialist with access to multiple vulnerability databases and threat feeds.”) and a task (e.g., “Find active CVEs matching the identified vulnerabilities. Include CVSS scores and official remediation guidance”).

In step 225, a security mitigation expert AI agent may perform mitigation planning. This may include creating a mitigation plan based on the CVE findings from the CVE researcher AI agent and the vulnerability analysis from the vulnerability researcher AI agent. This may include both immediate actions and long-term hardening measures.

For example, the security mitigation expert AI agent may: (1) identify the actual system configuration and architecture to confirm the presence of any relevant CVEs.; (2) if applicable, update the target system to a version that addresses the identified vulnerabilities; (3) disable or removing vulnerable components if they are present on the system; (4) apply any available patches from vendors for known vulnerabilities affecting their products; (5) implement ongoing monitoring and maintenance to ensure that the systems remain up-to-date and protected against potential threats; and (6) conduct a thorough investigation to validate the applicability of these CVEs to the specific target system, reviewing additional data and system configuration details as needed.

In one embodiment, the LLM may format the request to find the access points, and the mitigations are then performed based on the information from the MITRE ATT&CK data source details. The security mitigation expert AI agent may patch the vulnerable systems as per instructions given in the mitigation strategies from the MITRE ATT&CK.

For example, the security mitigation expert AI agent may provide the LLM with a persona (e.g., “Former CISO with 15 years’ experience in enterprise security and risk management. CISSP certified.”) and a task (e.g., “Recommend and implement security mitigations”).

In step 230, a database security engineer AI agent may perform hardening on the information system(s). This may include implementing security hardening measures on the information system(s), such as applying patches, modifying configurations, and enabling security features.

The database security engineer AI agent may update the target system to a version that addresses the identified vulnerabilities, disable or remove vulnerable components if they are present on the system, apply any available patches from vendors for known vulnerabilities affecting their products, implement ongoing monitoring and maintenance to ensure that the systems remain up-to-date and protected against potential threats, and/or conduct a thorough investigation to validate the applicability of these CVEs to the specific target system, reviewing additional data and system configuration details as needed.

For example, the security mitigation expert AI agent may provide the LLM with a persona (e.g., “A DB Admin specializing in security hardening and compliance implementations”) and a task (e.g., “Implement security hardening measures”).

In step 235, a technical report writer AI agent may generate and provide a final report. The final report may include CVE information with CVSS scores, mitigation strategies implemented, database hardening measures, compliance recommendations (e.g., GDPR, PCI-DSS, HIPAA), and visual charts of vulnerability distribution.

For example, the security mitigation expert AI agent may provide the LLM with a persona (e.g., “Technical writer with specialization in cybersecurity reports and compliance documentation”) and a task (e.g., “Generate comprehensive security reports”).

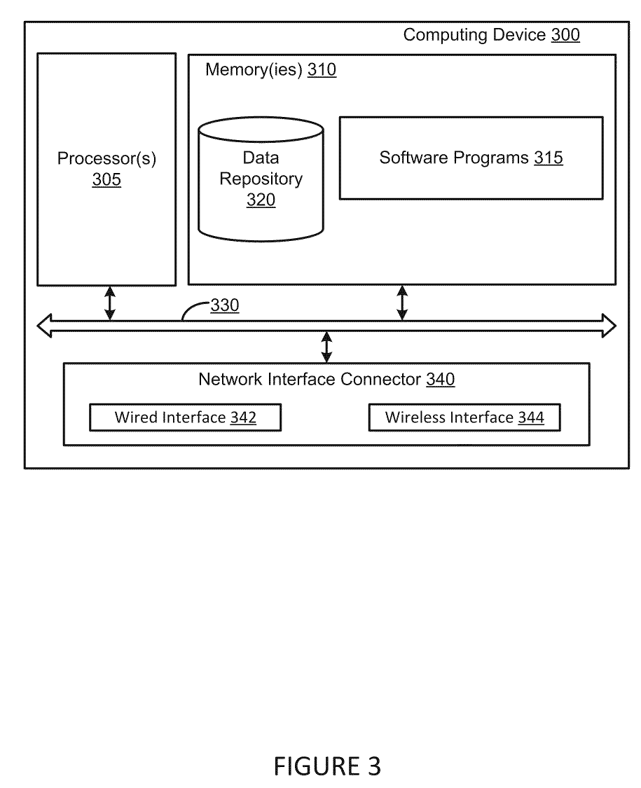

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

What is claimed is:

1. A method, comprising:
performing, by a senior penetration tester artificial intelligence (AI) agent executed by an electronic device, an initial breach on an information system using SQL injection;
prompting, by the senior penetration tester AI agent executed by the electronic device, a large language model (LLM) for potential entry points from results of the initial breach;
exfiltrating, by a data exfiltration specialist AI agent executed by the electronic device, sensitive data from the results of the initial breach, resulting in an exfiltration report;
prompting, by a vulnerability researcher AI agent executed by the electronic device, the LLM to analyze the exfiltration report and identify exploited vulnerabilities;
prompting, by a common vulnerability exposure (CVE) researcher AI agent executed by the electronic device, the LLM to find all active CVEs matching the identified exploited vulnerabilities;
performing, by a security mitigation expert AI agent executed by the electronic device, mitigation planning; and
implementing, by a database security engineer AI agent executed by the electronic device, security hardening measures on the information system based on the mitigation planning.

2. The method of claim 1, further comprising:
generating, by a technical report writer AI agent executed by the electronic device, a final report.

3. The method of claim 1, wherein each of the prompts comprises a persona for the LLM to assume and a task for the LLM to perform.

4. The method of claim 3, wherein the task in the prompt from the senior penetration tester AI agent comprises identify and exploit database vulnerabilities from results of the SQL injection.

5. The method of claim 3, wherein the task in the prompt from the data exfiltration specialist AI agent comprises exfiltrate and structure stolen data into reports.

6. The method of claim 3, wherein the task in the prompt from the vulnerability researcher AI agent comprises analyze exploited vulnerabilities and create a technical report, including vulnerability types, exploit methods, and impacted components.

7. The method of claim 3, wherein the task in the prompt from the CVE researcher AI agent comprises find active CVEs matching identified vulnerabilities.

8. The method of claim 3, wherein the task in the prompt from the security mitigation expert AI agent comprises recommend and implement security mitigations.

9. The method of claim 3, wherein the task in the prompt from the database security engineer AI agent comprises implement the security hardening measures.

10. The method of claim 1, wherein the security hardening measures comprise applying patches, modifying configurations, and/or enabling security features.

11. A non-transitory computer readable storage medium, including instructions stored thereon, which when read and executed by one or more computer processors, cause the one or more computer processors to perform steps comprising:
performing an initial breach on an information system using SQL injection;
prompting a large language model (LLM) for potential entry points from results of the initial breach;
exfiltrating sensitive data from the results of the initial breach, resulting in an exfiltration report;
prompting the LLM to analyze the exfiltration report and identify exploited vulnerabilities;
prompting the LLM to find all active CVEs matching the identified exploited vulnerabilities;
performing mitigation planning; and
implementing security hardening measures on the information system based on the mitigation planning.

12. The non-transitory computer readable storage medium of claim 11, further comprising:
generating a final report.

13. The non-transitory computer readable storage medium of claim 11, wherein each of the prompts comprises a persona for the LLM to assume and a task for the LLM to perform.

14. The non-transitory computer readable storage medium of claim 13, wherein the task comprises identify and exploit database vulnerabilities from results of the SQL injection.

15. The non-transitory computer readable storage medium of claim 13, wherein the task comprises exfiltrate and structure stolen data into reports.

16. The non-transitory computer readable storage medium of claim 13, wherein the task comprises analyze exploited vulnerabilities and create a technical report, including vulnerability types, exploit methods, and impacted components.

17. The non-transitory computer readable storage medium of claim 13, wherein the task comprises find active CVEs matching identified vulnerabilities.

18. The non-transitory computer readable storage medium of claim 13, wherein the task comprises recommend and implement security mitigations.

19. The non-transitory computer readable storage medium of claim 13, wherein the task comprises implement the security hardening measures.

20. The non-transitory computer readable storage medium of claim 11, wherein the security hardening measures comprise applying patches, modifying configurations, and/or enabling security features.
